(19) United States
(12) Patent Application Publication
(10) Pub. No.: US 2005/0139283 A1
(43) Pub. Date: Jun. 30, 2005

(54) Apparatus and method for dropping liquid crystal

(75) Inventors: Ching Wei Chiang, Miao-Li (TW); Yen Chung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 10/997,524

(22) Filed: Nov. 24, 2004

(30) Foreign Application Priority Data
Dec. 31, 2003 (TW) 92137544

(51) Int. Cl. B67C 3/00

(52) U.S. Cl. 141/8

(57) ABSTRACT

A liquid crystal dropping apparatus (100) includes a vacuum chamber (80), and two liquid crystal dispensers (42, 52). The liquid crystal dispensers are installed in the vacuum chamber, and are adapted to release different desired amounts of liquid crystal simultaneously. A liquid crystal dropping method using the apparatus comprises the steps of: providing two liquid crystal dispensers; providing a first substrate divided into two panels, and positioning the first substrate so that each panel is below a corresponding liquid crystal dispenser; and releasing different amounts of liquid crystal onto said panels simultaneously via said liquid crystal dispensers. The liquid crystal dropping apparatus and method can drop the needed liquid crystal onto the two different panels of the substrate simultaneously.

### BACKGROUND OF THE INVENTION

1. Field of the Invention

The present invention relates to an apparatus and a method for filling liquid crystal into a liquid crystal display (LCD) cell, and especially to an apparatus and a method for dropping liquid crystal using one-drop-filling (ODF) technology.

2. Description of Prior Art

An LCD cell generally comprises two panels, a peripheral sealant, and a multiplicity of liquid crystal molecules retained between the panels and sealant. The sealant is printed on one of the panels, and is subsequently adhered to the other panel. The panels and the sealant cooperatively form a space therebetween, with the liquid crystal molecules being filled in the space.

There are generally two methods used for filling the liquid crystal molecules into the space. The first method is to fill the liquid crystal molecules through filling ports. This method comprises the following steps: firstly, printing a sealant on a first panel, wherein the sealant is rectangular and has one or more gaps that function as filling ports; secondly, combining a second panel with the first panel and curing the sealant, whereby a space is enclosed by the sealant and the two panels; thirdly, immersing the filling ports in a liquid crystal in a vacuum chamber; and fourthly, introducing gas into the vacuum chamber to make the liquid crystal molecules fill up the space.

The second method is the so-called one-drop-filling (ODF) method. This method comprises the following steps: firstly, printing a sealant on a first panel, wherein the sealant is rectangular and continuous, and a space is enclosed by the sealant and the first panel; secondly, releasing liquid crystal molecules into the space drop by drop using a dispenser; and thirdly, combining a second panel with the first panel and curing the sealant.

Referring to FIG. 5, this shows a liquid crystal dropping apparatus as disclosed in U.S. Pat. No. 5,511,591. The apparatus comprises a vacuum chamber 8, a vacuum pump 9, an X-Y moving table 26, and a liquid crystal dispenser 10. The vacuum pump 9 is used to evacuate the inside of the vacuum chamber 8 to a pressure of about 0.1 torr. The table 26 is installed in the vacuum chamber 8, and can move in X and Y directions. The liquid crystal dispenser 10 is installed above the table 26, and comprises a capillary 63 used to release liquid crystal drop by drop.

Also referring to FIGS. 6A to 6C, an ODF method for dropping liquid crystal using the above-described liquid crystal dropping apparatus comprises the following steps: firstly, setting a lower panel 23 on the table 26, a periphery of the lower panel 23 having adhering paste 24 applied thereon; secondly, dropping a desired amount of liquid crystal L down onto the surface of lower panel 23 inside the loop of applied adhering paste 24; and thirdly, placing an upper panel 25 on the lower panel 23, and curing the adhering paste 24 with light from lamps 28, thereby laminating the upper panel 25 onto the lower panel 23.

Because the desired amount of liquid crystal L can be easily controlled by the dispenser 10, the ODF method is more convenient than the method of filling liquid crystal molecules through filling ports. In addition, the ODF method has a shorter filling time, and wastes less liquid crystal material.

In many modern manufacturing facilities, the lower panel 23 is not simply a single glass substrate. Referring to FIG. 7, for example, a glass substrate 200 may require processing. The glass substrate 200 has a regular size corresponding to an industry standard. The glass substrate 200 is divided into four panels 201, 202, 203, 204 of equal size. The above-described liquid crystal dropping apparatus is convenient to use on the glass substrate 200, and the overall dropping time can be reduced. This is especially the case where the liquid crystal dropping apparatus comprises a plurality of dispensers 10.

Referring to FIG. 8, in another example, a glass substrate 300 is divided into two large panels 301, 303 and two small panels 302, 304. The small panels 302, 304 are defined in addition to the large panels 301, 303, in order to make full use of the glass substrate 300. In this case, the above-described liquid crystal dropping apparatus has some drawbacks. The desired amount of liquid crystal corresponding to one kind of panel is controlled by the dispenser 10 before dropping. Therefore when the size of the panel is changed, the corresponding manipulator must adjust the dispenser 10 again. Even in the case where the liquid crystal dropping apparatus comprises a plurality of dispensers 10, the liquid crystal dropping apparatus cannot drop liquid crystal onto different panels of a glass substrate simultaneously.

Thus, a new liquid crystal dropping apparatus and method which overcome the above-mentioned disadvantages are desired.

### SUMMARY OF THE INVENTION

An object of the present invention is to provide a liquid crystal dropping apparatus that can drop liquid crystal onto different panels of a glass substrate simultaneously.

Another object of the present invention is to provide a liquid crystal dropping method that can drop liquid crystal onto different panels of a glass substrate simultaneously.

In order to achieve the first object set out above, a liquid crystal dropping apparatus comprises a vacuum chamber and two liquid crystal dispensers. The liquid crystal dispensers are installed in the vacuum chamber, and are used to release different desired amounts of liquid crystal simultaneously.

In order to achieve the second object set out above, an exemplary liquid crystal dropping method comprises the steps of: providing two liquid crystal dispensers; providing a first substrate divided into two panels, and positioning the first substrate so that each panel is below a corresponding liquid crystal dispenser; and releasing different amounts of liquid crystal onto said panels via said liquid crystal dispensers simultaneously.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a cutaway side view of a liquid crystal dropping apparatus according to the present invention, showing a lower glass substrate inside the apparatus;

FIG. 2 is a flow chart of an exemplary liquid crystal dropping method according to the present invention;

FIG. 3 is an enlarged view of part of FIG. 1, showing dropping of liquid crystal onto the lower glass substrate;

FIG. 4 is a similar to FIG. 3, but showing an upper glass substrate laminated onto the lower glass substrate, and curing of a sealant between the substrates by lamps;

FIG. 5 is a cutaway view of a conventional liquid crystal dropping apparatus;

FIGS. 6A to 6C are schematic, side cross-sectional views showing successive stages in a liquid crystal dropping method using the liquid crystal dropping apparatus of FIG. 5;

FIG. 7 is an enlarged, top plan view of a glass substrate divided into four panels of equal size; and

FIG. 8 is an enlarged, top plan view of a glass substrate divided into four panels of different sizes.

### DETAILED DESCRIPTION OF THE INVENTION

Reference will now be made to the drawings to describe the present invention in detail.

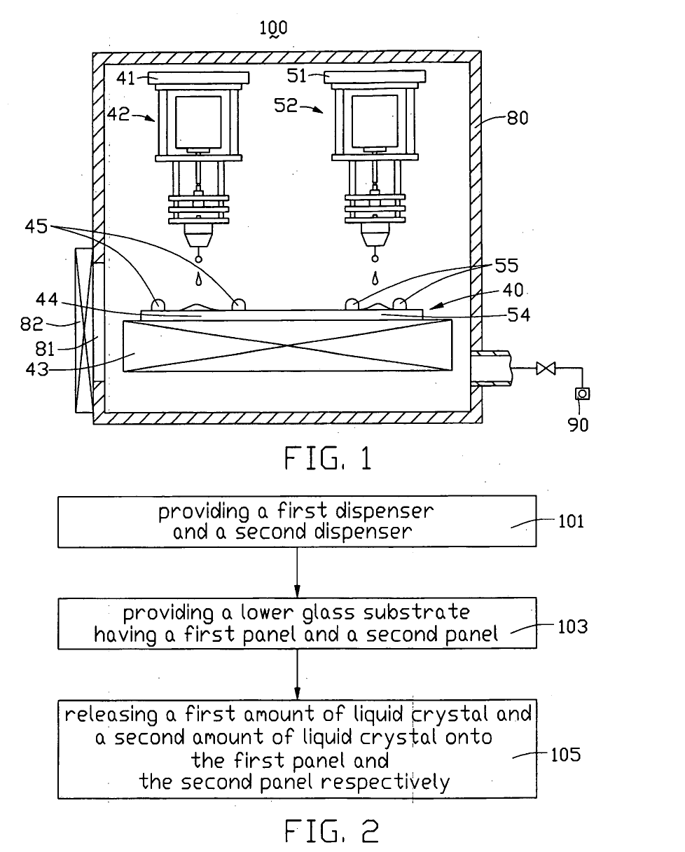

Referring to FIG. 1, a liquid crystal dropping apparatus 100 in accordance with the present invention comprises a vacuum chamber 80, a first liquid crystal dispenser 42, a first holding device 41, a second liquid crystal dispenser 52, a second holding device 51, and a table 43.

The vacuum chamber 80 comprises an opening 81, a cover 82, and a vacuum pump 90. The opening 81 is used to transfer a lower glass substrate 40 having a first lower panel 44 and a second lower panel 54 into the vacuum chamber 80, and transfer the lower glass substrate 40 out of the vacuum chamber 80 after the liquid crystal is dropped. The first lower panel 44 is larger than the second lower panel 54. The vacuum pump 90 is used to evacuate the inside of the vacuum chamber 80 to a vacuum state after the cover 82 seals the opening 81.

The first liquid crystal dispenser 42, first holding device 41, second liquid crystal dispenser 52, second holding device 51 and table 43 are installed in the vacuum chamber 80. The first holding device 41 is an X-Y moving mechanism, and is used to hold the first liquid crystal dispenser 42. The second holding device 51 is an X-Y moving mechanism, and is used to hold the second liquid crystal dispenser 52.

The table 43 is an X-Y moving table, and is installed below the liquid crystal dispensers 42 and 52. When the glass substrate 40 is set on the table 43, the first lower panel 44 of the glass substrate 40 is under the first dispenser 42, and the second lower panel 54 of the glass substrate 40 is under the second dispenser 52.

The first liquid crystal dispenser 42 comprises a first controller (not shown). The first controller can control the first liquid crystal dispenser 42 regarding the amount of liquid crystal released and the duration of release of liquid crystal. The amount of released liquid crystal corresponds to the size of the first lower panel 44. The second liquid crystal dispenser 52 comprises a second controller (not shown). The second controller can control the second liquid crystal dispenser 52 regarding the amount of liquid crystal released and the duration of release of liquid crystal. The amount of released liquid crystal corresponds to the size of the second lower panel 54.

Because the liquid crystal dropping apparatus 100 has two dispensers 42 and 52, two different amounts of liquid crystal can be controlled and dropped by the two dispensers 42 and 52 simultaneously. Thus, even though the glass substrate 40 has the two different panels 44, 54 needing liquid crystal dropped thereon, the liquid crystal dropping apparatus 100 can still drop the needed liquid crystal onto the panels 44, 54 simultaneously.

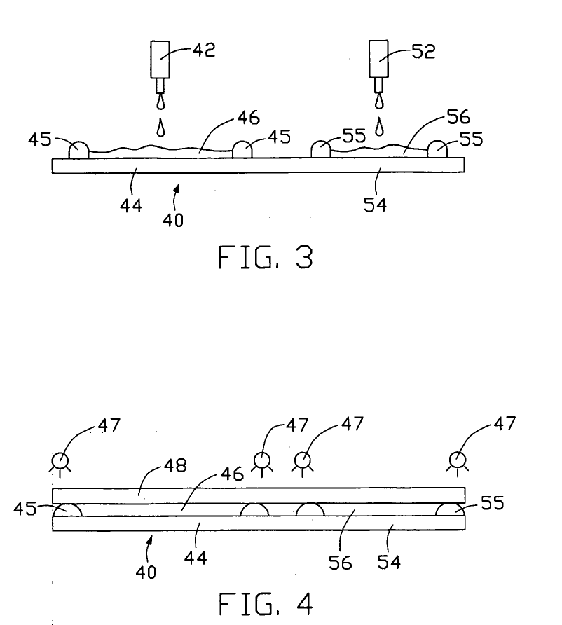

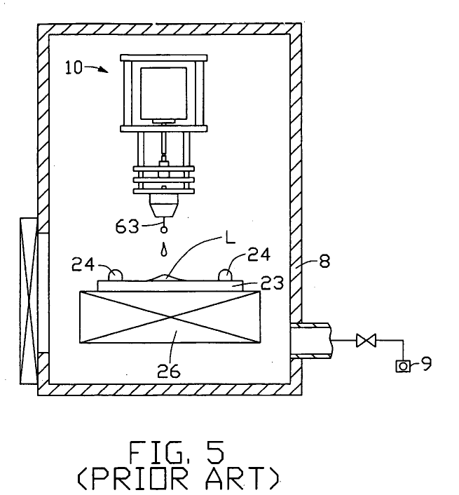

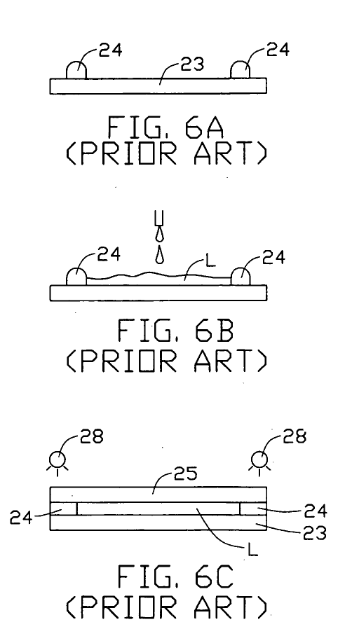

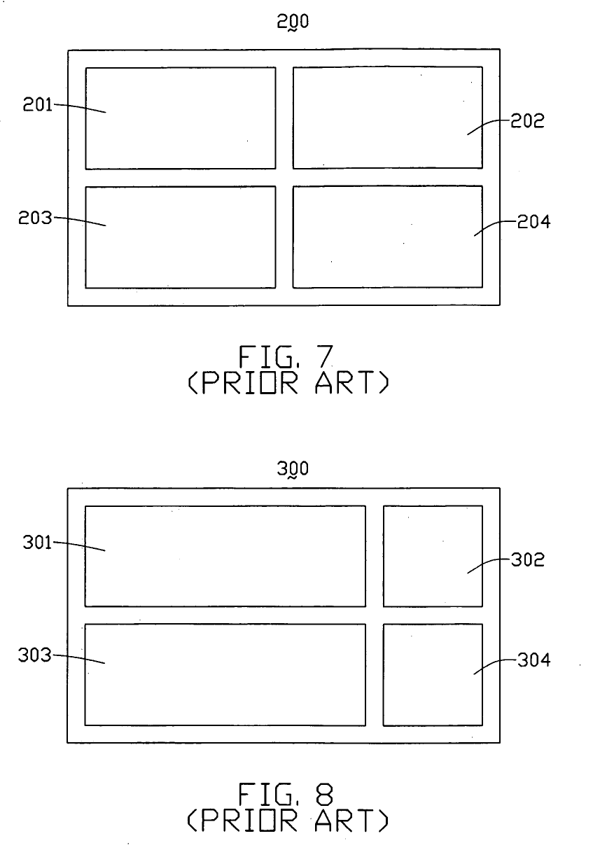

FIG. 2 is a flow chart of the exemplary liquid crystal dropping method according to the present invention, which is performed using the liquid crystal dropping apparatus 100. Details of the method will be described as follows, with reference to FIG. 3 and FIG. 4 also.

In step 101, the first liquid crystal dispenser 42 and the second liquid crystal dispenser 52 are provided. As described above, the first liquid crystal dispenser 42 and the second liquid crystal dispenser 52 are controlled by different controllers, and the release amounts and times of the dispensers 42 and 52 are different.

In step 103, the lower glass substrate 40 having the first lower panel 44 and the second lower panel 54 is provided. Referring to FIG. 1 and FIG. 3, the lower glass substrate 40 is set on the table 43. The first lower panel 44 corresponds to the first dispenser 42, and the second lower panel 54 corresponds to the second dispenser 52. The first lower panel 44 is larger than the second lower panel 54. Adhering sealants 45 and 55 are applied along margins of the first lower panel 44 and the second lower panel 54, respectively. The sealants 45 and 55 are made of an ultraviolet curable sealing material, and can be cured by ultraviolet radiation.

In step 105, different amounts of liquid crystal are released by the dispensers 42, 52 simultaneously. Referring to FIG. 3, a first amount of liquid crystal 46 is released onto the first lower panel 44 by the first liquid crystal dispenser 42, and a second amount of liquid crystal 56 is released onto the second lower panel 54 by the second liquid crystal dispenser 52. The first amount of liquid crystal 46 is greater than the second amount of liquid crystal 56.

Finally, referring to FIG. 4, an upper glass substrate 48 is laminated onto the lower glass substrate 44, with the sealants 45 and 55 being cured by ultraviolet radiation from lamps 47.

When the liquid crystal is dropped, the first holding device 41 and the second holding device 42 can each move in X and Y directions, so that the liquid crystal is evenly distributed on the panels 44 and 54. Alternatively, the holding devices 41 and 51 can be fixed, with only the table 43 moving in X and Y directions.

In summary, because different amounts of liquid crystal corresponding to the sizes of the panels 44, 54 can be controlled and dropped by the two dispensers 42 and 52, the method of present invention provides simultaneous liquid crystal dropping onto a glass substrate having different panels. Thus the processing time of liquid crystal dropping is reduced. The method speeds up the manufacturing of an LCD cell.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A liquid crystal dropping apparatus, comprising:
a vacuum chamber; and
at least two liquid crystal dispensers installed in the vacuum chamber and adapted to release different desired amounts of liquid crystal.

2. The liquid crystal dropping apparatus as recited in claim 1, wherein the vacuum chamber comprises an opening for passing a substrate therethrough, a cover for sealing the opening, and a vacuum pump for evacuating the inside of vacuum chamber.

3. The liquid crystal dropping apparatus as recited in claim 1, further comprising at least two holding devices installed in the vacuum chamber, for holding said liquid crystal dispensers respectively.

4. The liquid crystal dropping apparatus as recited in claim 3, wherein the holding devices are X-Y moving mechanisms.

5. The liquid crystal dropping apparatus as recited in claim 1, wherein each liquid crystal dispenser comprises a controller, which controls a time period during which liquid crystal is released by the liquid crystal dispenser.

6. The liquid crystal dropping apparatus as recited in claim 1, wherein each liquid crystal dispenser comprises a controller, which controls an amount of liquid crystal released by the liquid crystal dispenser.

7. The liquid crystal dropping apparatus as recited in claim 1, further comprising a table below said liquid crystal dispensers.

8. The liquid crystal dropping apparatus as recited in claim 7, wherein the table is an X-Y moving table.

9. A liquid crystal dropping method, comprising:
providing at least two liquid crystal dispensers;
providing a first substrate divided into at least two panels, and positioning the first substrate so that each panel is below a corresponding liquid crystal dispenser; and
releasing different amounts of liquid crystal onto said panels simultaneously via said liquid crystal dispensers.

10. The liquid crystal dropping method as recited in claim 9, further comprising the step of laminating a second substrate onto the first substrate after the liquid crystal is released.

11. The liquid crystal dropping method as recited in claim 9, further comprising the step of adhering sealants along margins of said panels before the liquid crystal is released.

12. A liquid crystal dropping apparatus assembly, comprising:
a vacuum chamber;
at least two liquid crystal dispensers installed in the vacuum chamber and releasing liquid crystals of different desired characters; and
a glass substrate including two areas with differently characterized liquid crystals applied thereon.
